(19) United States
(12) Patent Application Publication
(10) Pub. No.: US 2007/0094494 A1
(43) Pub. Date: Apr. 26, 2007

(54) Defending against sybil attacks in sensor networks

(75) Inventors: Satyajit Banerjee, Sheoraphuly (IN); Debapriyay Mukhopadhyay, Chakdaha (IN); Suman Roy, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/258,976

(22) Filed: Oct. 26, 2005

(51) Int. Cl. H04L 9/00

(52) U.S. Cl. 713/157

(57) ABSTRACT

A node B of a communication network receives a partial certificate from each of a plurality of nodes Aᵢ in the communication network, constructs an identity certificate based on the partial certificates received from the nodes Aᵢ, and transmits only a relevant part of the identity certificate to any requesting node C in order to get its authenticity verified by the node c.

### TECHNICAL FIELD OF THE INVENTION

The present invention relates to sensor networks which are resistant to attacks such as a Sybil attack.

### BACKGROUND OF THE INVENTION

Sensor networks are now being deployed on a planned or ad hoc basis to perform monitoring and protection in a wide variety of different applications such as life monitoring, military target tracking, security, and hazardous environment applications. Many of these applications are life critical. This critically suggests that sensor networks need adequate security, especially considering that sensor networks have certain vulnerabilities. For example, the nodes of sensor networks may be physically captured or breached by an adversary who can thus carry out different modes of harmful attacks and/or active and passive eavesdropping.

The Sybil attack, introduced by Douceur, is one of the vulnerabilities of a sensor network. In a Sybil attack, a single entity, such as a node, illegitimately presents multiple identities to the network. Physically captured nodes claiming multiple illegitimate identities can control a substantial fraction of the network, leading to malfunction of the network's basic operational protocols including routing protocols, resource allocation protocols, and misbehavior detection protocols.

Sybil attacks can be prevented if each honest entity (such as a node) possesses an unforgettable identity certificate issued by some trusted Certifying Authority, and if the entity is required to produce that certificate as proof of its authenticity before the entity is allowed to take part in network activities. These conditions imply that, in order to induce a Sybil attack, the adversary has to necessarily forge valid certificates. Also, these conditions mean that the trusted Certifying Authority must be suitably designed so that the sensor network can defend itself against Sybil attack.

Certification services have been around for quite a long time. However, existing certification techniques designed for general purpose networks are not suitable for sensor networks due to some typical incompatibility features. Accordingly, a new certification scheme is required to defend sensor networks against Sybil attacks.

In public key cryptography, identity forgery by fake nodes is prevented by a trusted Certifying Authority that issues a digital identity certificate to each node and that has a public key. The identity certificate, as the name implies, is a node's identity, and each node in the network can verify the validity of any other node's identity certificate by use of the public key of the Certifying Authority. Though elegant and robust, this arrangement has a major drawback with respect to sensor networks. Typically, the nodes of a sensor network are resource constrained devices in terms of storage, computation, and transmission power. A public key based scheme requires extensive computation and long message transmissions that quickly deplete the resources (such as the battery) of the sensor nodes. On the other hand, symmetric key based techniques are orders of magnitude cheaper and, thus, are well suited for sensor network applications.

Another typical property of a sensor network that creates trouble in defending it against different attacks is its inherent intrusion model. Nodes of a sensor network can be physically captured by an adversary and are subject to active and/or passive eavesdropping. Accordingly, a centralized trusted Certifying Authority is not suitable, since the Certifying Authority node could be physically captured leading to a single point failure. On the other hand, ensuring a complete intrusion-free system using any sophisticated security technique can be costly and unrealistic. As a tradeoff, a paradigm shift from preventing intrusion completely to tolerating some intrusion may be a rational choice.

Such a paradigm can be supported by choosing a (t, n) threshold technique for a certification scheme. A (t, n) threshold means that, in a network having n nodes, a threshold t is established where t is a number of nodes less than n. In this (t, n) threshold paradigm, the functionality of a Certifying Authority is uniformly distributed to each sensor node in the sensor network so that any t out of n nodes in the sensor network together can perform the functionality of a trusted Certifying Authority and can provide an individually verifiable certificate for each honest identity in the sensor network. The sensor network continues to function correctly as long as the number of captured nodes is less than t.

Moreover, nodes in a sensor network are generally deployed in large numbers and join or leave the network on the fly at any time. So, the certification technique needs to be scalable and robust in a dynamic sensor network. Also, sensor nodes may come from different vendors and, thus, cannot be pre-configured with identity certificates. Hence, it is desirable for the certification technique to operate in a heterogeneous network. Finally, as a node needs to get its identity certificate validated every time it initiates a network activity, the validation procedure should be reasonably fast so that network performance is not unduly compromised.

The present invention is intended to implement one or more of these attributes and/or to solve one or more of these or other problems.

### SUMMARY OF THE INVENTION

According to one aspect of the present invention, a method is performed by a node B of a communication network. The node B has an identity, and the method comprises the following: receiving a partial certificate from each of a plurality of t number of nodes Aᵢ in the communication network; constructing an identity certificate based on the partial certificates received from the nodes Aᵢ, wherein all of the partial certificates are required by the node B to construct the identity certificate; and, transmitting only a relevant part of the identity certificate to another node of the communication network in order to permit the other node to verify the identity of the node B.

According to another aspect of the present invention, a method is performed by a node B of a communication network. The node B has an identity, and the method comprises the following: receiving a partial certificate from each of a plurality of nodes Aᵢ in the communication network, wherein each of the partial certificates is in accordance with a bi-variate secret polynomial of degree (t−1) given by the following equation:

$$f ( x , y ) = {\sum }_{i = 0}^{t - 1} {\sum }_{j = 0}^{t - 1} {a}_{ij} {x}^{i} {y}^{j} ( mod p )$$

wherein x and y are variables, wherein p is a number, wherein aᵢⱼ are coefficients, wherein Aᵢ are identities of the nodes Aᵢ, wherein B is the identity of the node B, and wherein t is a number representing a threshold number of nodes; constructing an identity certificate based on the partial certificates received from the nodes Aᵢ, wherein all of the partial certificates are required by the node B to construct the identity certificate, and wherein the identity certificate is derived from the equation; and, transmitting at least a relevant part of the identity certificate to another node of the communication network in order to permit the other node to verify the identity of the node B.

According to still another one aspect of the present invention, a method is performed by a node B of a communication network. The node B has an identity, and the method comprises the following: when the node B wishes to transmit a communication to a receiver node, requesting validation of the identity certificate of the node B from the receiver node; when the node B receives a request for validation of an identity certificate of a transmitter node, calculating a partial secret share based on the identities of the node B and an identity of the transmitter node, receiving the relevant part of the identity certificate of the transmitter node, and comparing the calculated partial secret share to the received relevant part of the identity certificate for a match; when the node B is a new node entering the communication network, requesting partial certificates and partial shares from other nodes of the communication network, calculating a secret share based on the partial shares, and calculating an identity certificate based on the calculated secret share and the requested partial certificates, wherein each of the partial shares contains corresponding partial information about a secret share of a corresponding other node with respect to the node B, and wherein each of the partial certificates contains corresponding partial information about an identity of a corresponding other node with respect to the node B; when the node B receives a request for a partial certificate and a partial share from a new node entering the communication network, authenticating the new node, calculating a partial share and a partial certificate, and sending the calculated partial share and partial certificate to the new node; and, when it is time to refresh identity certificates of the nodes of the communication network and the node B is a member of a refreshment coalition of nodes, selecting a new set of coefficients, constructing a new secret share based on the new set of coefficients, and constructing a new identity certificate based on the new secret share and on new partial certificates received from the other nodes in the refreshment coalition.

According to still another one aspect of the present invention, a method performed by a new node joining a sensor network comprises the following: providing a first level identity that authenticates the new node to a predetermined number of existing nodes of the sensor network; receiving elements of a second level identity from each of the existing nodes in terms of identity certificates and secret shares pertaining to at least some of the existing nodes; building an identity certificate for the new node based on the received elements; and, transmitting only a relevant part of the identity certificate to another node of the sensor network in order to permit the other node to verify the identity of the new node.

According to a further aspect of the present invention, a communication network comprises a plurality of nodes, each of the nodes has a-corresponding unique identity, and each node has the following capabilities: when the node wishes to transmit a communication to a receiver node, the node requests validation of its identity certificate from the receiver node; when the node receives a request for validation of an identity certificate of a transmitter node, the node calculates a partial secret share based on its identity and on an identity of the transmitter node, the node receives a relevant part of the identity certificate of the transmitter node, and the node compares the calculated partial secret share to the received relevant part of the identity certificate for a match; when the node is a new node entering the communication network, the node requests partial certificates and partial shares from other working nodes of the communication network, the node calculates a secret share based on the partial shares, and the node calculates an identity certificate based on the calculated secret share and the requested partial certificates, wherein each of the partial shares contains corresponding partial information about a secret share of a corresponding other working node with respect to the node, and wherein each of the partial certificates contains corresponding partial information about an identity of a corresponding other working node with respect to the node; when the node receives a request for a partial certificate and a partial share from a new node entering the communication network, the node authenticates the new node, the node calculates a partial share and a partial certificate, and the node sends the calculated partial share and partial certificate to the new node; and, when it is time to refresh identity certificates of the nodes of the communication network and the node is a member of a refreshment coalition of nodes, the node selects a new set of coefficients, the node constructs a new secret share based on the new set of coefficients, and the node constructs a new identity certificate based on the new secret share and on new partial certificates received from the other nodes in the refreshment coalition.

### BRIEF DESCRIPTION OF THE DRAWINGS

These and other features and advantages will become more apparent from a detailed consideration of the invention when taken in conjunction with the drawings in which:

FIG. 1 illustrates a network comprising a plurality of nodes which are configured in accordance with an embodiment of the present invention;

FIG. 2 illustrates a representative one of the nodes of the sensor network shown in FIG. 1; and, FIGS. 3A-3E illustrate a flow chart of a program that may be executed by each of the nodes of FIG. 1.

### DETAILED DESCRIPTION

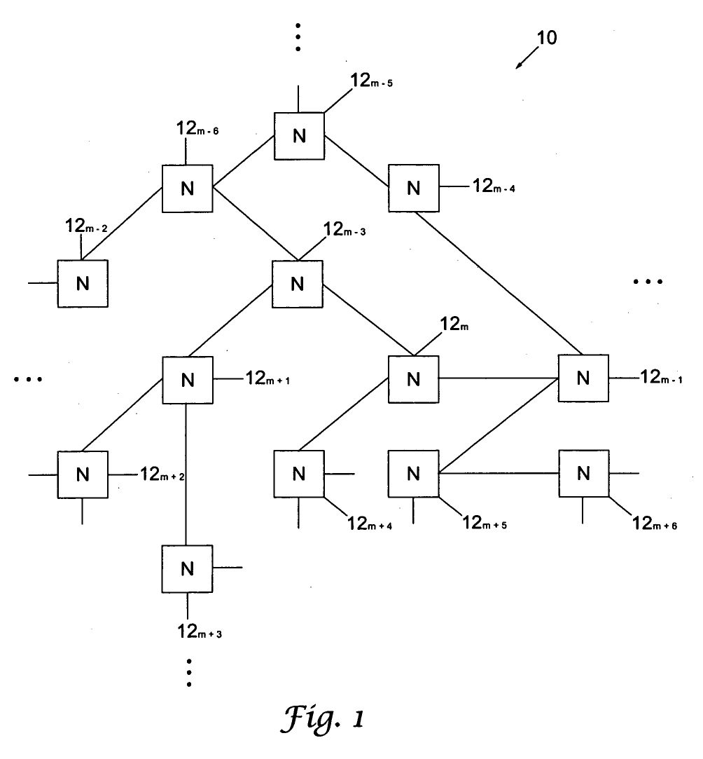

FIG. 1 shows a network 10 comprising nodes 12₁, . . . , 12ₘ₋₆, 12ₘ₋₅, 12_{m-4, 12}ₘ₋₃, 12ₘ₋₂, 12ₘ₋₁, 12ₘ, 12ₘ₊₁, 12ₘ₊₂, 12ₘ₊₃, 12ₘ₊₄, 12ₘ₊₅, 12ₘ₊₆, . . . , 12ₙ. The network 10, for example, may be a sensor network such as a wireless sensor network. Accordingly, the links between the nodes 12₁, . . . , 12ₘ₋₆, 12ₘ₋₅, 12_{m-4, 12}ₘ₋₃, 12ₘ₋₂, 12ₘ₋₁, 12ₘ, 12ₘ₊₁, 12ₘ₊₂, 12ₘ₊₃, 12ₘ₊₄, 12ₘ₊₅, 12ₘ₊₆, . . . , 12ₙ may be wireless links such as infrared links, ultrasonic links, RF links, or any other type of wireless link. Alternatively, these links may be provided by electrical wires, optical fiber cables, or other physical connections between the nodes.

As shown in FIG. 1, each of the nodes may be in direct communication with one or more other nodes and may be in indirect communication with one or more of the remaining nodes. For example, the node 12ₘ₋₃ is in direct communication with the nodes 12ₘ₋₆, 12ₘ, and 12ₘ₊₁, and is in indirect communication with other nodes such as the nodes 12ₘ₋₂ and 12ₘ₋₅ through node 12ₘ₋₆. The nodes 12ₘ₋₆, 12ₘ, and 12ₘ₊₁ are considered to be one-hop neighbors of the node 12ₘ₋₃ because they are in direct communication with the node 12ₘ₋₃.

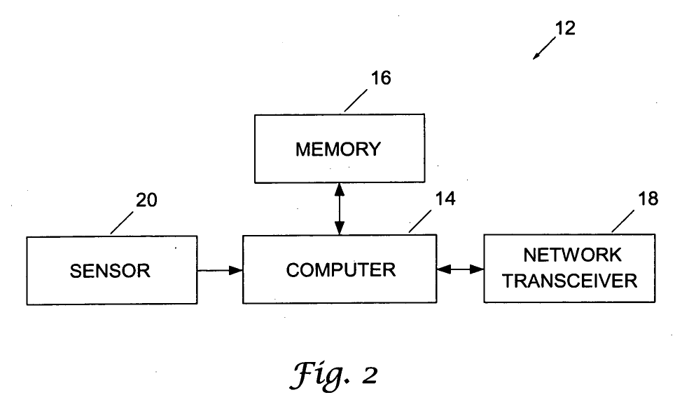

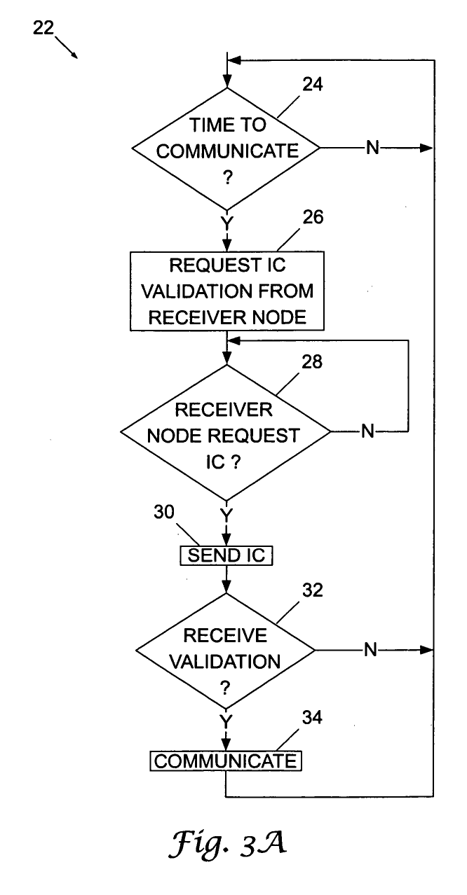

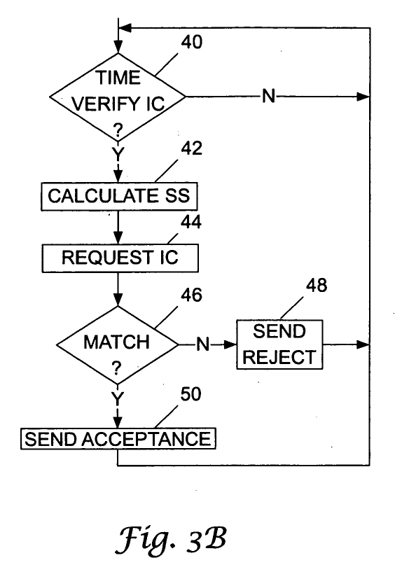

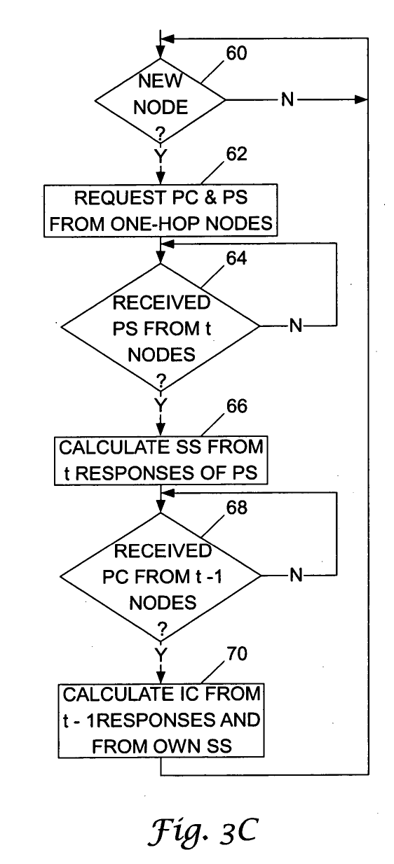

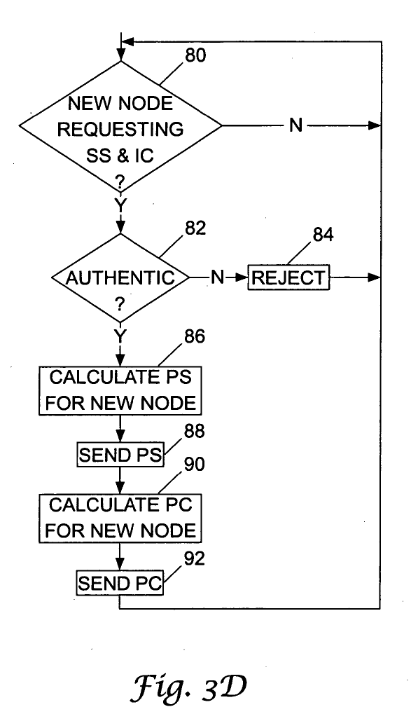

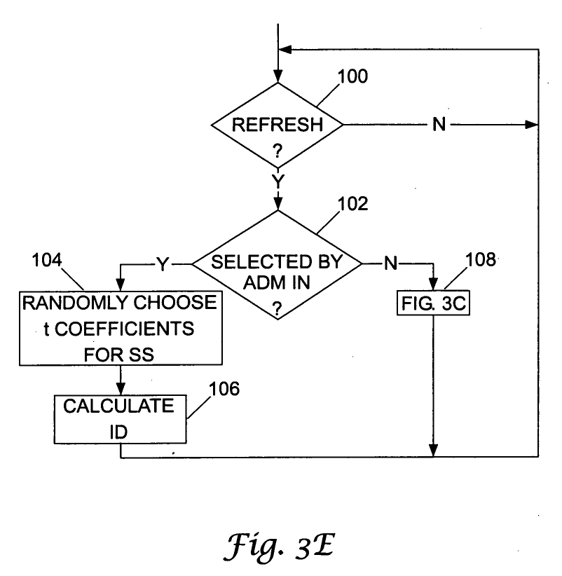

As shown in FIG. 2, the node 12, which, for example, may be representative of each of the nodes shown in FIG. 1, includes a computer 14, a memory 16, and a network transceiver 18.

The memory 16 stores a program, such as the one shown in FIGS. 3A-3E, whose execution by the computer 14 implements identity certification according to an embodiment of the present invention.

The network transceiver 18 permits communication between the node 12 and the other nodes in the network 10, including the communication that is required to implement identity certification. The network transceiver 18 supports communication with other nodes of the network 10 such as the one-hop neighbors of the node 12. The communications transmitted or received by the network transceiver 18 can be wireless communications over wireless links as discussed herein. Alternatively, the communications transmitted or received by the network transceiver 18 can be communications over physical or other links as also discussed herein.

In the case where the node 12 is a sensor node, the node 12 also includes a sensor 20. The sensor 20 can be any sort of sensor suitable for the particular application of the network 10.

As discussed above, a Sybil attack in a network (such as the network 10) is an attack in which one or more malicious nodes assume a plurality of illegitimate identities. These illegitimate identities may be referred to as Sybil nodes. Generally, a Sybil node can acquire an identity in two ways. It can fabricate a new identity, or it can steal an identity from a legitimate node which has either left the network or is being destroyed by the attacker.

Identity based certification can be used as a preventive measure against a Sybil attack. It may be assumed that each of the nodes in the network 10 has, in its possession, a unique tamper-resistant identification k which will be verified physically by the Certifying Authority in order to issue a certificate to the node for its identity. If the intent of a malicious node is to claim many identities for itself, the malicious node has to bypass the process of obtaining a certificate because it cannot change the tamper-resistant identity and convince the Certifying Authority of a new identity. Forging certificates turns out to be the only realistic option for bypassing the process of obtaining a certificate and carrying out a Sybil attack on the network 10. Therefore, if identity certification is cryptographically secure, the possibility of a Sybil attack is very remote.

The concept of identity certificates is well established in asymmetric (public) key cryptography in which the identity and public key information of each entity in a network is signed by the secret key of the Certifying Authority. The signature can be validated also by any third party with the help of the public key of the Certifying Authority. Here, every entity has two types of key components, a private key to which only the entity has access, and a public key which may be published or distributed on request.

The private key and the public key are inversely related. One key is used to encrypt a message and another is used to decrypt it, or, in terms of signing, one key is used to sign a message and the other key is used to verify the message's signature. Although the order in which the keys are applied is thought to be irrelevant, it is generally accepted that the key that is used to decrypt or sign must be kept secret (private) and cannot, hopefully, be derived from the public key, which is used to encrypt or verify.

The advantage of the asymmetric key system is that two nodes can communicate securely without exchanging secret keys. Also, the asymmetric key system is well suited for providing authentication, integrity, and non-repudiation services through the signature. For sensor network applications, there is a major disadvantage of the asymmetric key system in that a large amount of mathematical computations is required to process the encryption/decryption or signatures.

Symmetric key cryptography, on the other hand, is characterized by the use of a single key to perform both the encrypting/decrypting or signing functions. Symmetric key systems are generally much faster to execute electronically than asymmetric key systems. However, symmetric key systems require the secret key to be shared amongst the communicating parties. Since a shared secret key is subject to discovery by an adversary, the shared secret key needs to be changed often and kept secure during distribution and in use. The consequent requirements of choosing, distributing, and storing a shared secret key without error and without loss is a very severe problem.

In symmetric key cryptography, the concept of a signature is hazy, and there is only one key which is secret. Thus, there is a need for a suitable analog for the identity certificate in the symmetric key domain:

A certificate in the symmetric key cryptography domain can be viewed as an object that cannot be forged, that is provided by the trusted Certifying Authority to each node, and that is only used by each node to validate the authenticity of its identity. However, the problem is that, unlike the symmetric key cryptography domain, once a node X produces its identity certificate to some node Y for validation, the node Y can offer the identity of the node X to some other node Z in order to falsely acquire successful validation. So, identity validation can be performed with only partial information about the certificate, i.e., the node X only produces the partial information that is of interest to the node Y, and the node Y validates the identity certificate of the node X based on that partial information only. This arrangement prevents the node Y from pretending that it is the node X, because the node Y does not know about the partial certificate information that the node X uses to acquire validation of its identity by the node Z.

As can be seen, this arrangement relies on only partial validation of an identity certificate. Therefore, when only partial information is used, this arrangement needs to ensure that it is reasonably improbable for a node using a fake identity to convince other nodes of its authenticity.

An additional problem is that every time the node X is validated by different nodes A₁, A₂, . . . , Aₖ, some partial information about the identity certificate is made known and, thus, the whole identity certificate of the node X is revealed over the course of sufficient time. However, partial validation is useful because the partial information related to an identity certificate can be refreshed at regular intervals. That is, if t number of uses of the partial information by the node X to validate its identity certificate is required for an attacking node to discover the identity certificate of the node X, then the identity certificate that the node X uses should be refreshed before the t number of uses of that partial information occurs.

As indicated above, nodes in a network can be physically captured. Thus, centralizing the Certifying Authority in a single node can lead to a single point of failure of the network. Accordingly, it is desirable to uniformly distribute the functionality of the Certifying Authority among the n nodes of the network (in terms of some “secret-shares” provided by a trusted Dealer) so that any s nodes, where s≧t, can together issue a valid certificate to a new node. It is further desirable to dispense with a centralized trusted Dealer who provides the secret shares to each of the nodes. In fact, the functionality of the trusted Dealer also should be uniformly distributed amongst the nodes with a similar condition, i.e., that any nodes s, where s≧t, can together issue valid secret shares to new nodes. These two features mean that identity certification is truly distributed and self-sufficient.

The following terms may be defined as follows:

(i) an Identity Certificate (C) is basically an analog of a certificate in the symmetric key domain such that each working node in the network 10 holds an Identity Certificate, such that each node of the network 10 relies on those Identity Certificates to validate the authenticity of the other nodes, and such that Identity Certificates are also used to validate and generate Secret Shares;

(ii) a Secret Share (S) is held by each working node, and the purpose of a Secret Share is to validate and generate Identity Certificates;

(iii) a Partial Certificate (PC) is partial information about the Identity Certificate of a node such that a requesting node receives a Partial Certificate from t other nodes and can uniquely construct its own Identity Certificate with those t different Partial Certificates, and such that the t other nodes construct the Partial Certificates for the requesting node using their respective Secret Shares without revealing the Secret Shares themselves;

(iv) a Partial Share (PS) is partial information about the Secret Share of a node such that a requesting node receives a Partial Share from t other nodes and can uniquely construct its Secret Share with those t different Partial Shares, and such that the t other nodes construct the Partial Shares for the requesting node using their respective Identity Certificates without revealing the Identity Certificates themselves; and,

(v) Per Node Certificate Information (PNCI) of a node is the combination of its Identity Certificate and its Secret Share where the Identity Certificate and Secret Share components of the Per Node Certificate Information are complementary to each other as one validates and generates the other.

The notion of threshold cryptography may also be used in the symmetric key domain of identity certification. Therefore, identity certification should have the following attributes:

(i) Each node can validate the Identity Certificates of the other nodes individually, which ensures that any two nodes in the network 10 can build a temporary mutual trust for communication;

(ii) Any s out of n honest nodes, where s≧t, and where t is a threshold number of working nodes, should be able to provide an unforgettable Identity Certificate to a requesting node, so that the functionality of the Certifying Authority is distributed across the nodes of the network 10 and so that any t out of n number of these nodes together act like a Certifying Authority whereas less than t number of these nodes cannot act like a Certifying Authority;

(iii) Any s out of n working nodes, where s≧t, should be able to provide a Secret Share to a new node, which is one more step that ensures that the network 10 performs all its certificate related functionalities in a truly distributed fashion, and that rules out the existence of a central trusted Dealer who provides the Secret Shares to each node (instead, the functionality of the Dealer is also distributed across the nodes, subject to the same restriction that any t out of n number of nodes cumulatively act like a Dealer, whereas less than t nodes cannot);

(iv) Any t out of n number of working nodes should be able to initiate a Per Node Certificate Information refreshment phase such that, because any (t, n) threshold scheme can withstand at most (t−1) number of physical captures of the nodes, it is necessary to refresh the Per Node Certificate Information PNCI at regular intervals (i.e., given an unbounded time-window, an adversary can eventually break into the network 10 and physically capture t or more nodes, and such an attack can be prevented by a regular Per Node Certificate Information refreshment policy that leaves only a small quantum of time for the adversary to physically capture t or more nodes within the refreshment interval (the refreshment interval should be optimally tuned to the particular network)); and,

(v) The requesting node should be capable of verifying the received Partial Certificates and Partial Shares individually, which ensures that the requesting node is capable of verifying the correctness of the Partial Certificate or Partial Share received from each of the nodes of a chosen set of nodes that has t number of members in order to construct its Identity Certificate or Secret Share (otherwise, the requesting node could incorrectly construct its Identity Certificate or Secret Share resulting in the requesting node becoming unreliable or non-functional).

1. The Certification Process

Three assumptions can be made with respect to the nodes of the network 10.

First, every node in the network 10 has in its possession a unique identification k, which is assumed to be tamper-resistant. The assumption that the identification k of each node is unique is reasonable even though the nodes of the network 10 are manufactured by different vendors.

Second, depending on the spatial density of the nodes and the vulnerability of any deployed region, the threshold parameter t can be chosen so as to ensure that each node in the network 10 has at least a number t of one-hop neighbors. Thus, a new node can choose a group of t working nodes around it in order to construct its Secret Share and Identity Certificate where each node in the group is one-hop away from the new node. In this scenario, it is reasonable to assume that each node of the t member group can rely on some physical out-of-bound proof and biometric measure (such as finger prints) to justify the fact that the new node is authentic, i.e., well-behaved and uncaptured.

Third, there is no man-in-the-middle attack since there are standard cryptographic primitives to handle this attack independently. (A man-in-the-middle attack can be either active or passive eavesdropping by one party on the communications between two or more other parties.)

The nodes of the network 10 are programmed to implement identity certification using partial information according to the following bi-variate secret polynomial of degree (t−1):

$$f ( x , y ) = {\sum }_{i = 0}^{t - 1} {\sum }_{j = 0}^{t - 1} {a}_{ij} {x}^{i} {y}^{j} ( mod p ) \qquad ( 1 )$$

where p is a large prime number, where x and y are the two variables of the polynomial and are assigned values as discussed below, where mod is modulo, and where αᵢⱼ are coefficients randomly chosen from the set Z*ₚ for all i,j. Also, the threshold t is known a priori to all nodes in the network 10. Typically, the network administrator fixes the value for t and configures all nodes accordingly.

Each working node in the network 10 has an identification k, where 1≦k≦p, and stores two single-variate secret polynomials of degree (t−1) derived from equation (1). These two single-variate secret polynomials are designated as Secret Share Sₖ(x) and Identity Certificate Cₖ(y), and these two single-variate secret polynomials are defined as Sₖ(x)=f(x, k) and Cₖ(y)=f(k, y), respectively. Hence, each node has to store t coefficients for its Secret Share Sₖ(x) and t coefficients for its Identity Certificate Cₖ(y), i.e., the associated space complexity per node is 0(t). As both the Secret Share Sk(x) and the Identity Certificate Cₖ(y) are software entities and are provided to each working node when it joins the network 10, the nodes of the network 10 need not be pre-configured with this information. This flexibility allows the nodes manufactured by different vendors to interact seamlessly in identity certification.

It is worth observing that the family of Identity Certificates and Secret Shares form a grid like structure. Any t number of Secret Shares can provide t number of points on a particular Identity Certificate and, thus, can uniquely construct the Identity Certificate by Lagrange's interpolation method, since each Identity Certificate Cₖ(y) is a (t−1) degree single variable polynomial. Conversely, any t number of Identity Certificates can uniquely construct any Secret Share. These two properties are used to dispose of trusted and centralized bodies for the Certifying Authority and the Dealer. Note that the (t, n) threshold works independently only when there are already at least t working nodes. Thus, initializing the first t nodes in the network 10 should be explicitly done by the network administrator.

2. Each Honest Node in the Sensor Network 10 can Individually Verify Another Node's Certificate.

If it is assumed that a node A (the node whose identification k=A) is honest and wants to verify the Identity Certificate of a node B (the node whose identification k=B), node A first calculates its Secret Share S_{A}(B) from its Secret Share S_{A}(B) polynomial, namely evaluating S_{A}(x) at x=B. Node A then asks node B to furnish the value of its Identity Certificate C_{B}(y) evaluated at A, i.e., C_{B}(A) . Node A accepts the Identity Certificate of node B if C_{B}(A) matches S_{A}(B) since S_{A}(B)=C_{B}(A)=f(B, A). Otherwise, node A rejects the Identity Certificate of node B. Because node A verifies the Identity Certificate of node B at y=A only, the verification process is very fast and only partial information of the Identity Certificate is released to the communication channel.

Verification of the value of the Identity Certificate of node B at a single point A is based on a reliance that node B actually possesses the appropriate Identity Certificate, namely C_{B}(y=A). Such reliance is reasonable because each Cₖ(y), where 1≦k≦p, is derived from the original random bi-variate secret polynomial f(x,y) given in equation (1) and, thus, C_{B}(A) can assume any value in Z*ₚ with uniform probability.

The probability that an attacking node B can fraudulently convince node A of its fraudulent identity by supplying the correct value of C_{B}(A) is

$$\frac{1}{p - 1} ,$$

since |Zₚ|=p−1. However, this probability is reasonably low because it decreases exponentially with the size of p. This probability remains unchanged even if up to (t−1) misbehaving nodes transparently form a coalition and try to fraudulently convince node A that the nodes in the coalition possess the correct Identity Certificate for node B when, in fact, they are not node B. Since the coalition can at most manage to acquire (t−1) different points on C_{B}(y) with their respective Secret Shares, the nodes in the coalition cannot uniquely construct C_{B}(y). In fact, the coalition gets no information about the value of C_{B}(A).

Another important criterion is the number successful validations of an Identity Certificate before that Identity Certificate can be replicated by attacking nodes. As discussed above, every time an Identity Certificate is verified, some information is leaked. Though an honest node would delete the information once the validation is over, attacking nodes might present different identities to a target node in order to accumulate the required number (t) of points on the Identity Certificate polynomial of the target node so as to replicate the Identity Certificate of the target node. Therefore, as soon as the attacking nodes together accumulate t different points on the Identity Certificate of node B, they can uniquely construct the Identity Certificate for node B using Lagrange's interpolation method. Accordingly, the network 10 exhibits a (t−1) tolerance against Identity Certificate exposure.

The number of successful validations that an Identity Certificate of a node can withstand before its Identity Certificate can be illicitly replicated can be estimated using the following assumptions.

First, if node X wants to communicate with node Y, it is node X who has to get its certificate validated by node Y. This assumption is realistic and rules out the possibility that attacking nodes can take the initiative to discover the Identity Certificates of honest nodes.

Second, the case where (t−1) nodes are already physically captured is the worst case scenario for quickly discovering a node's valid Identity Certificate.

Third, the attacking nodes are spatially scattered uniformly. This assumption is valid in the case where the nodes are mobile. The assumption also makes sense for immobile networks because a cluster of attacking nodes implies some gross attack or physical security problem in a particular region, and identity certification will be quickly broken with the capture of one more node in this location.

The probability that the Identity Certificate of an honest node being verified by a captured node is

$$\frac{t - 1}{n - 1} ,$$

where t is the threshold discussed herein and n is the number of nodes in the network. The probability Pᵢ that the Identity Certificate of the target node will be revealed by the attacking nodes at the ith validation of the target node's Identity Certificate, where i≧t, can be viewed as t−1 validations of the Identity Certificate of a target node (in any order) by any attacking node in the first (i−1) Bernoulli trials followed by the ith validation once again by some attacking node. Hence, based on a binomial probability distribution, the probability Pᵢ is given by the following equation:

$${P}_{i} = ( \begin{matrix}i - 1 \\ t - 1\end{matrix} ) {( \frac{t - 1}{n - 1} )}^{t - 1} {( \frac{n - t}{n - 1} )}^{i - t} ( \frac{t - 1}{n - 1} ) \qquad ( 2 )$$

Hence, the expected Number of Validations (NoV) required for discovering the Identity Certificate of a target node is given by the following equation:

$$E ( NoV ) = {\sum }_{i = t}^{∞} i {P}_{i} = {\sum }_{i = t}^{∞} i ( \begin{matrix}i - 1 \\ t - 1\end{matrix} ) {( \frac{t - 1}{n - 1} )}^{t} {( \frac{n - t}{n - 1} )}^{i - t} \qquad ( 3 )$$

This series evaluates to

$$( \frac{t}{t - 1} ) ( n - 1 ) = θ ( n )$$

for t≧2. Because the nodes of a network are generally deployed in large numbers, the value of n is typically large. Thus, the worst case analysis illustrates that a target node can safely have its Identity Certificate validated a reasonably large number of times, even if attacking nodes are present.

3. Any t Out of n Nodes can Provide an Identity Certificate C to a New Node B.

It may be assumed that a Secret Share is the first thing that is provided to a new node B followed by an Identity Certificate. Therefore, when node B requests an Identity Certificate, node B already possesses its Secret Share.

The one-hop neighbors of node B jointly issue an Identity Certificate to node B and may be designated nodes Aᵢ for 1≦i≦(t−1), i.e., nodes Aᵢ work together to help node B construct its Identity Certificate C_{B}(y). On verifying the authenticity of node B as discussed above, each of the nodes Aᵢ individually calculates a Partial Certificate S_{Ai}(B) for node B, and sends its Partial Certificate S_{Ai}(B) to the node B as its respective contribution. Moreover, node B calculates its own partial certificate S_{B} (B) based on the Secret Share that is already in its possession (see section 1, supra). In other words, node B receives t−1 ordered pairs (Aᵢ, S_{Ai}(B)) and calculates one ordered pair (B, S_{B}(B)) for a total of t ordered pairs.

Because Sₓ(B)=C_{B}(x), these t ordered pairs all correspond to t different points on the Identity Certificate of node B, namely C_{B}(y). From these t different points, node B can determine t coefficients of C_{B}(y) using Lagrange's interpolation method and, thus, can determine the single variate polynomial C_{B}(y) itself.

As can be seen, only (t−1) other nodes are needed by node B because node B generates one Partial Certificate for itself with its Secret Share. However, the process remains a (t, n) threshold process as the requesting node also participates in the process with other (t−1) helping nodes.

Since t many different points on the single-variate polynomial C_{B}(y) are necessary to uniquely construct it, and since a fewer number of points simply does not reveal any information about the certificate, it is not possible for any coalition of (t−1) or fewer nodes to issue an Identity Certificate of an arbitrary node. Likewise, node B cannot guess the Partial Certificates S_{Ai}(x) of the nodes Aᵢ due to same reason as presented in Section 2 above.

This Identity Certificate issuing process can cope with the scenario where the nodes of a network join the network and separate from the network on the fly. The only restriction is that the number of working nodes should be at least t, as Identity Certificate is a (t, n) threshold process. This Identity Certificate construction operation is slightly expensive, but happens very infrequently, when some new node joins the network or at the beginning of each Per Node Certificate Information refreshment interval.

4. Any t Out of n Nodes can Provide the Secret Share to a New Node.

The Secret Share is the first thing that is provided to a new node. So, at the time that a new node makes a request for its Secret Share, that new node does not hold any certificate related information and has to rely on t (not t−1) other nodes to help it construct its Secret Share.

It may be assumed that the new node is designated node B and that its one-hop neighbors are designated nodes Aₖ, where 1≦k≦t. The nodes Aₖ are arranged to jointly issue a Secret Share to node B, i.e., the nodes Aₖ work together to help node B calculate Secret Share S_{B}(x).

The process of constructing a Secret Share is similar in nature to the process of constructing an Identity Certificate IC described above. On verifying the authenticity of node B as described above, each of the nodes Aₖ individually calculates a Partial Share C_{A}_{ₖ}(B) for the node B, and sends its Partial Share C_{A}_{ₖ}(B) to the new node B as its respective contribution. Thus, node B. receives t ordered pairs (Aₖ, C_{A}_{ₖ}(B)). Because C_{A}_{ₖ}(B)=S_{B}(Aₖ) , these t ordered pairs correspond to t different points on the Secret Share S_{B}(x) of node B. From these t different points, node B can uniquely determine t coefficients of S_{B}(x) using Lagrange's interpolation method and, thus, can determine the polynomial S_{B}(x) itself.

Because t number of points on the single-variate polynomial S_{B}(X) are necessary to uniquely construct it, it is impossible for any coalition of (t−1) or fewer nodes to issue a Secret Share SS to a new node or to discover the secret Shares SS of other nodes. Also, node B cannot determine the Identity Certificate C_{A}_{ₖ}(y) of nodes Aₖ with the Partial Shares PS that it has received, due to same reason as presented in Section 2 above.

This Secret Share issuing technique can cope with nodes joining or leaving the network 10 on the fly, as long as the number of working nodes in the network 10 is at least t. This Secret Share issuing process also happens infrequently, when a new node joins the network and at the beginning of each Per Node Certificate Information refreshment interval.

There may be any desired amount of overlap between the nodes Aᵢ that are used to determine the Identity Certificate as described in Section 3 and the nodes Aₖ that are used to determine the Secret Share as described in Section 3. Hence, because there need not be any necessary overlap between these two sets of nodes, the nomenclature Aᵢ is used in connection with Section 3 above and the separate nomenclature Aₖ is used in connection with Section 4 above.

5. Any t Out of n Nodes can Initiate the Per Node Certificate Information Refreshment Phase.

The Per Node Certificate Information refreshment phase can be initiated by any t number of working nodes, e.g., Aⱼ, 1≦j ≦t. These nodes securely form a coalition under the supervision of the network administrator.

Then each refreshment node Aⱼ in the t member refreshment coalition randomly refreshes its (t−1) degree single-variate Secret Share polynomial to construct S_{A}_{_{j (ref)}}(x), i.e., basically each refreshment node Aⱼ randomly chooses a corresponding set of t number of coefficients for its secret share polynomial from |Z*ₚ|.

This independent choice made by the t number nodes of the refreshment coalition effectively refreshes (changes) the bi-variate polynomial given in equation (1) from f(x,y) to f_{ref}(x,y).

Each refreshment node Aⱼ then calculates its “refreshed” Identity Certificate C_{A}_{_{j (ref)}}(y) in the same manner as described above in section 3 with the help of the other (t−1) members of the coalition. These t nodes form the initial set of refreshed nodes.

Each of the remaining nodes then behaves as a new node and derives its Secret Share SS and Identity Certificate IC from already refreshed nodes in the same way as described in Sections 3 and 4 above.

6. The Partial Certificate PC and the Partial Share PS Received by the Requesting Node Should be Individually Verifiable.

As a group of t members can verify the authenticity of a new node by some out-of-bound physical proof and biometric, the new node in turn can also adopt the same strategy (under the supervision of the network administrator) to verify whether each member of the coalition is also authentic. Though such authenticity checking is an indirect means of verification, it could be a simple but efficient strategy for partial information verifiability.

Based on the above description, each of the nodes of the network 10 shown in FIG. 1 executes a program 22, such as the program shown by way of the flow charts of FIGS. 3A-3E, in order to carry out Identity Certification according to an embodiment of the present invention.

As shown in FIG. 3A, when it is time for a node, such as node B, to communicate with another node, such as node A, as determined at 24, node B transmits at 26 a request that its Identity Certificate be validated by node A. If node B then receives a request for Identity Certification verification at 28, node B at 30 sends its Identity Certification to node A. Assuming that node A verifies the Identity Certification of node B, node B will determine at 32 that its Identity Certificate has been verified, in which case node B will transmit at 34 its communication to node A.

As shown in FIG. 3B, when it is time for a node, such as node A, to verify the Identity Certificate of another node, such as node B, as determined at 40, node A at 42 calculates its Secret Share S_{A}(B), as described above in section 2, based on its own identity y=k and the identity x=k of the node B. Node A, at 44, then requests the Identity Certificate C_{B}(A) from node B. At 46, node A compares its calculated Secret Share S_{A}(B) to the Identity Certificate C_{B}(A) that it receives from node B. If its calculated Secret Share S_{A}(B) does not match the Identity Certificate C_{B}(A) that it receives from node B, node A at 48 sends a reject message to node B. On the other hand, if its calculated Secret Share S_{A}(B) matches the Identity Certificate C_{B}(A) that it receives from node B, node A at 50 sends a verification message to node B.

As shown in FIG. 3C, when a node enters or re-enters the network 10, it is a new node as indicated at 60. If the node is a new node, the node at 62 requests Partial Certificates and Partial Shares from its one-hop neighbors. When the node at 64 determines that it has received the Partial Shares from t ones of its one-hop neighbors, the node at 66 calculates its Secret Share based on the t ordered pairs as discussed above in section 4. Then, when the node at 68 determines that it has received the Partial Certificates from t−1 ones of its one-hop neighbors, the node at 70 calculates, as discussed above in section 3, (i) its own Secret Share (e.g., S_{B}(B) if the node is node B), and (ii) its Identity Certificate based on the t ordered pairs derived from the Partial Certificates that it has received from the t−1 ones of its one-hop neighbors and from the its own Secret Share that it has calculated.

As shown in FIG. 3D, if a node at 80 determines that it has received a request from a new node for a Secret Share and an Identity Certificate, and if the node determines at 82 that the new node is not authentic using the physical out-of-bound proof and biometric measure discussed above, the node at 84 sends a reject message to the requesting node. On the other hand, if the node at 80 determines that it has received a request from a new node for a Secret Share and an Identity Certificate, and if the node determines at 82 that the new node is authentic, the node at 86 calculates a Partial-Share as discussed above in Section 4 and at 88 sends the Partial Share to the requesting node. Then, the node at 90 calculates a Partial Certificate as discussed above in Section 3 and at 92 sends the Partial Certificate to the requesting node.

As shown in FIG. 3E, if the node determines at 100 that it is time to refresh, and if the node determines at 102 that it is a refreshment node i, the node i at 104 randomly and independently chooses t number of coefficients and constructs its Secret Share Sᵢ(x) based on these coefficients and the polynomial given by equation (1). Then, the node i calculates at 106 its Identity Certificate Cᵢ(y) with the help of the other t−1 refreshment nodes in the manner discussed above in connection with section 3. Accordingly, there should be t nodes that form the refreshment coalition. On the other hand, if the node determines at 100 that it is time to refresh and if the node determines at 102 that it is not a refreshment node i, the node is not yet refreshed and cooperates at 108 with any t number of nodes that have been refreshed to execute the portion of the program shown in FIG. 3C in order to refresh its Secret Share and its Identity Certificate. As mentioned above, execution of the portion of the program shown in FIG. 3E effectively adopts a new bi-variate polynomial of the form shown in Equation (1) because this polynomial now has a new refreshed set of coefficients.

Certain modifications of the present invention have been discussed above. Other modifications of the present invention will occur to those practicing in the art of the present invention. For example, FIG. 2 shows a node construction that can be used for each of the nodes in the network 10. However, the nodes of the network 10 may be differently constructed. Indeed, as discussed above, the nodes of the network 10 can be supplied by different vendors, but such different nodes can still be programmed to operate as claimed herein.

Furthermore, as discussed above, a node interacts with one-hop neighbors. However, a node may interact with other nodes as well.

In addition, the present invention has been described with particular reference to sensor networks. However, the present invention has applicability with other networks as well.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A method performed by a node B of a communication network, wherein the node B has an identity, the method comprising:
receiving a partial certificate from each of a plurality of t number of nodes Aᵢ in the communication network;
constructing an identity certificate based on the partial certificates received from the nodes Aᵢ, wherein all of the partial certificates are required by the node B to construct the identity certificate; and,
transmitting only a relevant part of the identity certificate to another node of the communication network in order to permit the other node to verify the identity of the node B.

2. The method of claim 1 wherein each of the partial certificates contains corresponding partial information about an identity of a corresponding node Aᵢ with respect to the node B.

3. The method of claim 1 further comprising:
receiving a partial share from each of a plurality of nodes Aₖ in the communication network;
constructing a secret share based on the partial shares received from the nodes Aₖ, and wherein all of the partial shares are required by the node B to construct the secret share; and,
wherein the constructing of an identity certificate comprises constructing the identity certificate based on the partial certificates received from the nodes Aᵢ and the secret share.

4. The method of claim 3 wherein each of the partial shares contains corresponding partial information about a secret share of a corresponding node Aₖ with respect to the node B, and wherein each of the partial certificates contains corresponding partial information about an identity of a corresponding node Aᵢ with respect to the node B.

5. The method of claim 3 wherein 1≦i≦t−1, wherein 1≦k≦t, and wherein t comprises a threshold number of nodes.

6. The method of claim 1 further comprising refreshing the identity certificate on a periodic basis.

7. The method of claim 6 wherein each of the partial certificates contains corresponding partial information about an identity of a corresponding node Aᵢ with respect to the node B.

8. The method of claim 6 further comprising:
receiving a partial share from each of a plurality of nodes Aₖ in the communication network;
constructing a secret share based on the partial shares received from the nodes Aₖ, and wherein all of the partial shares are required by the node B to construct the secret share; and,
wherein the constructing of an identity certificate comprises constructing the identity certificate based on the partial certificates received from the nodes Aᵢ and the secret share.

9. The method of claim 8 wherein each of the partial shares contains corresponding partial information about a secret share of a corresponding node Aₖ with respect to the node B, and wherein each of the partial certificates contains corresponding partial information about an identity of a corresponding node Aᵢ with respect to the node B.

10. The method of claim 8 wherein 1≦i≦t−1, wherein 1≦k≦t, and wherein t comprises a threshold number of nodes.

11. The method of claim 1 wherein the constructing of an identity certificate comprises constructing the identity certificate in accordance with a polynomial equation.

12. The method of claim 11 wherein the polynomial equation is of degree t−1, and wherein t comprises the number of nodes Aᵢ required to construct the identity certificate.

13. The method of claim 1 wherein the constructing of an identity certificate comprises constructing the identity certificate in accordance with a bi-variate polynomial equation.

14. The method of claim 11 wherein the bi-variate polynomial equation is of degree t−1, and wherein t comprises the number of nodes Aᵢ required to construct the identity certificate.

15. The method of claim 1 wherein the node B can be any node of the communication network.

16. A method performed by a node B of a communication network, wherein the node B has an identity, the method comprising:
receiving a partial certificate from each of a plurality of nodes Aᵢ in the communication network, wherein each of the partial certificates is in accordance with a bi-variate secret polynomial of degree (t−1) given by the following equation:
$$f ( x , y ) = {\sum }_{i = 0}^{t - 1} {\sum }_{j = 0}^{t - 1} {a}_{ij} {x}^{i} {y}^{j} ( mod p )$$
wherein aᵢⱼ are coefficients, wherein x and y are variables, wherein p is a number, wherein Aᵢ are identities of the nodes Aᵢ, wherein B is the identity of the node B, and wherein t is a number representing a threshold number of nodes;
constructing an identity certificate based on the partial certificates received from the nodes Aᵢ, wherein all of the partial certificates are required by the node B to construct the identity certificate, and wherein the identity certificate is derived from the equation; and,
transmitting a relevant part of the identity certificate to another node of the communication network in order to permit the other node to verify the identity of the node B.

17. The method of claim 16 wherein 1≦i≦t−1 for Aᵢ, and wherein t comprises a threshold number of nodes.

18. The method of claim 16 further comprising:
receiving a partial share from each of a plurality of nodes Aₖ in the communication network, wherein each of the partial certificates is derived in accordance with the equation;
constructing a secret share S_{B}(x) based on the partial shares received from the nodes Aₖ, wherein all of the partial shares are required by the node B to construct the secret share, and wherein the secret share is derived in accordance with the equation; and,
wherein the constructing of an identity certificate comprises constructing the identity certificate based on the partial certificates received from the nodes Aᵢ and the secret share.

19. The method of claim 18 wherein 1≦i≦t−1, wherein 1≦k≦t, and wherein t comprises a threshold number of nodes.

20. The method of claim 16 further comprising refreshing the identity certificate on a periodic basis.

21. The method of claim 20 wherein 1≦i≦t−1, and wherein t comprises a threshold number of nodes.

22. The method of claim 20 further comprising:
receiving a partial share from each of a plurality of nodes Aₖ in the communication network, wherein each of the partial certificates is derived in accordance with the equation;
constructing a secret share S_{B}(x) based on the partial shares received from the nodes Aₖ, wherein all of the partial shares are required by the node B to construct the secret share, and wherein the secret share is derived in accordance with the equation; and,
wherein the constructing of an identity certificate comprises constructing the identity certificate based on the partial certificates received from the nodes Aᵢ and the secret share.

23. The method of claim 22 wherein 1≦i≦t−1, wherein 1≦k≦t, and wherein t comprises a threshold number of nodes.

24. The method of claim 20 wherein the refreshing of the identity certificate comprises:
refreshing the set of coefficients α*ᵢⱼ;
constructing a refreshed single variate secret share S_{B}*(x) based on the new set of coefficients α*ᵢⱼ, and wherein the refreshed single variate secret share S_{B}*(x) is derived from the equation; and,
constructing a refreshed identity certificate C_{B}*(y) based on the refreshed secret share S_{B}*(x) and on refreshed partial certificates received from nodes Aⱼ, wherein 1≦j≦t.

25. The method of claim 22 wherein p is a large prime number, and wherein aᵢⱼ are coefficients randomly chosen from the set {1, 2, . . . , p−1}.

26. The method of claim 16 wherein the node B can be any node of the communication network.

27. A method performed by a node B of a communication network, wherein the node B has an identity, the method comprising:
when the node B wishes to transmit a communication to a receiver node, requesting validation of an identity certificate of the node B from the receiver node;
when the node B receives a request for validation of an identity certificate of a transmitter node, calculating a partial secret share based on the identity of the node B and on an identity of the transmitter node, receiving a relevant part of the identity certificate of the transmitter node, and comparing the calculated partial secret share to the received relevant part of the identity certificate for a match;
when the node B is a new node entering the communication network, requesting partial certificates and partial shares from other nodes of the communication network, calculating a secret share based on the partial shares, and calculating an identity certificate based on the calculated secret share and the requested partial certificates, wherein each of the partial shares contains corresponding partial information about a secret share of a corresponding other node with respect to the node B, and wherein each of the partial certificates contains corresponding partial information about an identity of a corresponding other node with respect to the node B;
when the node B receives a request for a partial certificate and a partial share from a new node entering the communication network, authenticating the new node, calculating a partial share and a partial certificate, and sending the calculated partial share and partial certificate to the new node; and,
when it is time to refresh identity certificates of the nodes of the communication network and the node B is a member of a refreshment coalition of nodes, selecting a new set of coefficients, constructing a new secret share based on the new set of coefficients, and constructing a new identity certificate based on the new secret share and on new partial certificates received from the other nodes in the refreshment coalition.

28. The method of claim 27 wherein the node B can be any node of the communication network.

29. A method performed by a new node joining a sensor network comprising:
providing a first level identity that authenticates the new node to a predetermined number of existing nodes of the sensor network;
receiving elements of a second level identity from each of the existing nodes in terms of identity certificates and secret shares pertaining to at least some of the existing nodes;
building an identity certificate for the new node based on the received elements; and,
transmitting only a relevant part of the identity certificate to another node of the sensor network in order to permit the other node to verify the identity of the new node.

30. A communication network comprising a plurality of nodes, wherein each of the nodes has a corresponding unique identity, and wherein each node has the following capabilities:
when the node wishes to transmit a communication to a receiver node, the node requests validation of its identity certificate from the receiver node;
when the node receives a request for validation of an identity certificate of a transmitter node, the node calculates a partial secret share based on its identity and on an identity of the transmitter node, the node receives a relevant part of the identity certificate of the transmitter node, and the node compares the calculated partial secret share to the received relevant part of the identity certificate for a match;
when the node is a new node entering the communication network, the node requests partial certificates and partial shares from other working nodes of the communication network, the node calculates a secret share based on the partial shares, and the node calculates an identity certificate based on the calculated secret share and the requested partial certificates, wherein each of the partial shares contains corresponding partial information about a secret share of a corresponding other working node with respect to the node, and wherein each of the partial certificates contains corresponding partial information about an identity of a corresponding other working node with respect to the node;
when the node receives a request for a partial certificate and a partial share from a new node entering the communication network, the node authenticates the new node, the node calculates a partial share and a partial certificate, and the node sends the calculated partial share and partial certificate to the new node; and,
when it is time to refresh identity certificates of the nodes of the communication network and the node is a member of a refreshment coalition of nodes, the node selects a new set of coefficients, the node constructs a new secret share based on the new set of coefficients, and the node constructs a new identity certificate based on the new secret share and on new partial certificates received from the other nodes in the refreshment coalition.
